(19) United States
(12) Patent Application Publication
(10) Pub. No.: US 2012/0101946 A1
(43) Pub. Date: Apr. 26, 2012

(54) Method and system for distributed check processing at a plurality of sites

(76) Inventor: David Scott Jones, Frisco, TX (US)

(21) Appl. No.: 10/686,628

(22) Filed: Oct. 17, 2003

(51) Int. Cl. G06Q 40/00

(52) U.S. Cl. 705/45

(57) ABSTRACT

According to one embodiment, the present invention relates to a method and a system for distributed check processing at a plurality of sites. A computer implemented method for check processing comprises the steps of receiving a mail item comprising a payment product at a mail facility; identifying a routing code associated with the mail item; routing the mail item to a payment processing system, based on the routing code; at the payment processing system, extracting the payment product from the mail item; electronically transmitting payment data associated with the payment product to an intended recipient for processing; and destroying the payment product at the payment processing system wherein the payment processing system and the mail facility are local.

### FIELD OF THE INVENTION

The present invention relates generally to check processing and, more particularly, to a method and system for remittance and payment optimization at a plurality of distributed sites.

### BACKGROUND OF THE INVENTION

Check conversion generally refers to a payment that begins with a paper check and ends as an electronic debt. The paper check may be truncated/converted into an electronic debit entry early in the check handling cycle for subsequent electronic processing. Currently, checks may be converted using Automated Clearing House (ACH) payment system, ATM networks or other mechanisms. Other clearing channels may include Image Replacement Document (IRD), image exchange, and other channels. As a result, the efficiencies of electronic payments are realized while customers still continue to write paper checks.

Accounts Receivable Conversion (ARC) is a bank service that converts consumer check payments sent to a recipient, e.g., lockbox facility or dropbox location, into ACH electronic debits. The ACH system is a secure, private network that connects banks to one another through the Federal Reserve Board or other ACH operator. The ACH system enables electronic payments, such as automatic payroll deposits and debit card purchases, to be handled and processed. As a result, corporations and consumers can reduce or eliminate the use of paper checks to make routine and other payments. Most of the payments transferred over the ACH include recurring credit payments intended for the accounts of the receivers. Examples of typical payments include salaries, consumer and corporate bill payments, interest and dividends, and Social Security and other entitlement programs. Because of the ACH system's ability to process large volumes of payments efficiently and ability to allow a payee to debit the banking account of the payor, the ACH system is increasingly used for payments, such as insurance premiums, purchases of stock and consolidation of corporate cash balances.

In addition, a paper check may be replaced with a substitute paper check or IRD, which involves an image reprint of an original paper check and does not require an agreement between the parties. An IRD generally includes an image of the front and back of a check, conforms to industry standards, accurately and legibly represents all information on the original check, facilitates automated processing, bears legend (and other information) and includes indorsements and identification of the originator. IRDs provide for faster and more efficient collection and return of checks. Financial institutions may use electronics for processing and transmitting images for printing of substitute checks close to a receiving bank. Further, financial institutions may reduce physical sorting by sorting items electronically and printing substitute checks for return processing. In addition, branch and ATM deposits may be transmitted to processing centers to print substitute checks thereby reducing or eliminating transportation costs and efforts.

Paper checks are traditionally still one of the most common forms of payment. With new technologies and greater efficiencies in electronic transmissions, the use of paper checks are declining. However, as this form of payment is still widely used among consumers and other entities, billers want to preserve the paper check option for their customers. With this form of payment of still widely accepted and the different clearing channels involved, there are inefficiencies and associated costs that are associated with the paper collection process through these various clearing channels.

In view of the foregoing, it would be desirable to provide a method and system for check processing including remittance and payment optimization which overcome the above-described inadequacies and shortcomings.

### SUMMARY OF THE INVENTION

According to an embodiment of the present invention, a method and system for check processing at a plurality of distributed sites.

According to an exemplary embodiment of the present invention, a computer implemented method for processing payment products comprises the steps of receiving a mail item comprising a payment product at a mail facility; identifying a routing code associated with the mail item; routing the mail item to a payment processing system, based at least in part on the routing code; at the payment processing system, extracting the payment product from the mail item; electronically transmitting payment data associated with the payment product to an intended recipient for processing; and destroying the payment product at the payment processing system wherein the payment processing system and the mail facility are local.

In accordance with other aspects of this particular exemplary embodiment, the routing code comprises a zip code; the routing code comprises one or more of an address, a post office box identifier, and a tracking code; the routing code comprises a combination of numbers and letters; the payment processing system is located at the mail facility; the payment data comprises a portion of the payment product that is scanned for electronic transmission; the payment data comprises a scanned image of the payment product; one or more items associated with the payment product are electronically transmitted with the payment product; the one or more items comprise one or more of remittance advice, a coupon, a statement and accounts receivable data; the intended recipient identifies a payment type based on the payment data; the intended recipient further determines an appropriate clearing path, based at least in part on the payment type; the appropriate clearing path comprises one or more of automated clearing house, image replacement document and image exchange channels; the mail item is not sent into a regular mail channel; and the payment product comprises one or more or a consumer check, corporate check, cashier check, and money order.

In accordance with another exemplary embodiment, a computer implemented system for processing payment products comprises a mail module that receives a mail item comprising a payment product at a mail facility, identifies a routing code associated with the mail item; and routes the mail item based at least in part on the routing code; and a payment processing system that receives the mail item, extracts the payment product from the mail item; electronically transmits payment data associated with the payment product to an intended recipient for processing; and destroys the payment product at the payment processing system wherein the payment processing system and the mail facility are local.

In accordance with another exemplary embodiment, at least one signal embodied in at least one carrier wave for transmitting a computer program of instructions configured to be readable by at least one processor for instructing the at least one processor to execute a computer process for processing payment products, the computer process comprising receiving means for receiving a mail item comprising a payment product at a mail facility; identifying means for identifying a routing code associated with the mail item; routing means for routing the mail item to a payment processing system, based at least in part on the routing code; at the payment processing system, extracting means for extracting the payment product from the mail item; transmitting means for electronically transmitting payment data associated with the payment product to an intended recipient for processing; and destroying means for destroying the payment product at the payment processing system wherein the payment processing system and the mail facility are local.

In accordance with another exemplary embodiment, an article of manufacture for check processing comprising at least one processor readable carrier; and instructions carried on the at least one carrier; wherein the instructions are configured to be readable from the at least one carrier by at least one processor and thereby cause the at least one processor to operate so as to: receive a mail item comprising a payment product at a mail facility; identify a routing code associated with the mail item; route the mail item to a payment processing system, based at least in part on the routing code; at the payment processing system, extract the payment product from the mail item; electronically transmit payment data associated with the payment product to an intended recipient for processing; and destroy the payment product at the payment processing system wherein the payment processing system and the mail facility are local.

### BRIEF DESCRIPTION OF THE DRAWINGS

In order to facilitate a fuller understanding of the present invention, reference is now made to the appended drawings. These drawings should not be construed as limiting the present invention, but are intended to be exemplary only.

FIG. 1 is an exemplary flowchart illustrating a method for check processing, in accordance with an embodiment of the present invention.

FIG. 2 is an exemplary system for check processing at a distributed postal site, in accordance with an embodiment of the present invention.

FIG. 3 is an exemplary system for check processing at a distributed postal site, in accordance with an embodiment of the present invention.

### DETAILED DESCRIPTION OF EXEMPLARY EMBODIMENT(S)

An embodiment of the present invention is directed to a method and system for check processing at a plurality of distributed postal sites.

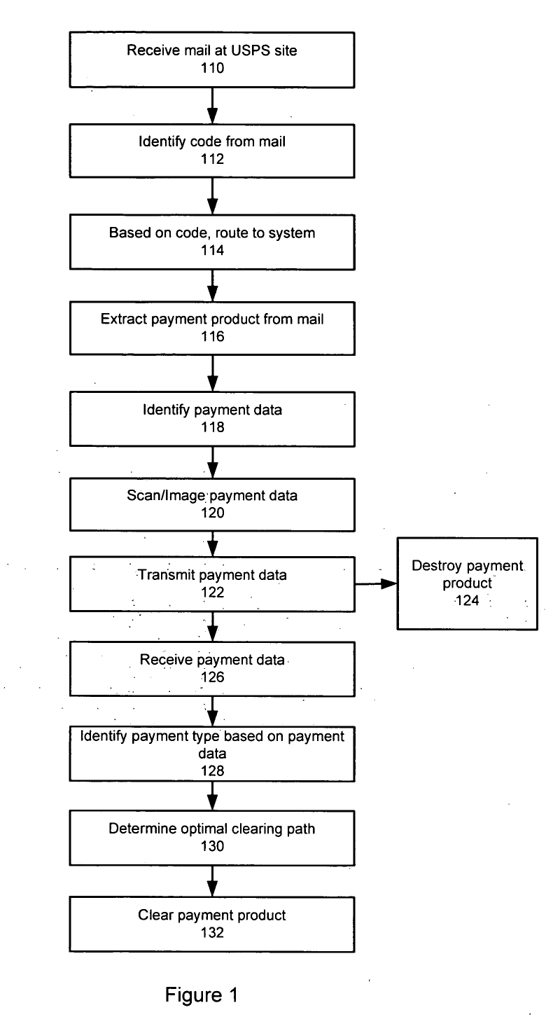

FIG. 1 is an exemplary flowchart illustrating a method for electronic check conversion, in accordance with an embodiment of the present invention. A consumer (or other entity) may mail a payment in an envelope or other mail item. The envelope may include postage and an intended recipient's address. For example, an entity (e.g., financial institution, etc.) may provide the consumer with a return envelope, with or without postage. The payment may include a check or other payment product and may be accompanied by associated paperwork, which may include remittance advice, coupon, statement, etc.

At step 110, the mail item may be received at a postal site, e.g., United States Postal Service (USPS) site, more specifically, at a mail processing facility or other conventional mail drop off location. The entity (e.g., a financial institution, bank, etc.) may provide customers with a code, such as a USPS zip code, address, post office box or other identifier that may be used to route the mail item. The entity may provide a return envelope with a pre-printed address and/or code.

At step 112, the code may be identified from the mail item. For example, an entity may be assigned a code that customers may use in mailing payments. A financial institution may be assigned a special zip code where customers of the financial institution may mail payments using an address that includes the zip code. The zip code is used by the postal site to route the mail item to the system of an embodiment of the present invention. In another example, the code may be any identifier that may include letters, numbers and/or a combination. The code may be any identifier that may be used by the customer of an entity in addressing a payment and by the postal site to route the mail item to an appropriate system of an embodiment of the present invention. In another example, the code may represent a code that identifies a mail item and/or a code (e.g., a tracking code) tracks a mail item through the mail channels.

At step 114, based on the code, the mail item may be routed to a system of an embodiment of the present invention. The system may include a co-located equipment and/or software which may be associated with the financial institution, postal site, USPS, or other entity. The system may be located at the postal site or at a nearby location. For example, the code may indicate to the postal site that the mail item is to be routed to a system of an embodiment of the present invention, rather than through the regular mail stream.

At step 116, a payment product (e.g., check) may be extracted from the mail item. For example, the envelope may be opened and the payment product may be extracted. This step may be performed automatically. In addition, associated paperwork may be extracted and identified with the payment product. For example, associated paperwork may include remittance advice, coupon, statement, accounts receivable data and/or other data associated with the payment product. Billing information may be gathered and associated with the payment product. For example, accounts receivable data may be gathered and matched with the payment product. In another example, the payment product may be matched with a coupon.

In addition, there may be certain mail items that may require or need special handling. For example, certain mail items may be of a size that is not sortable or other restrictions may be encountered by the system of an embodiment of the present invention. These items may be acted on remotely or by a personnel located at the site, e.g., USPS branch.

At step 118, payment data may be identified from the payment product. For example, payment data may include a Magnetic Ink Character Recognition (MICR) line, payment amount, routing number, transit number, payee information, payor information and/or other identifier associated with the payment product.

At step 120, the payment data may be scanned or imaged. For example, the payment product may be scanned. In another example, a portion of the payment product may be scanned, which may include an identifier and/or other data, such as a MICR line, etc. Associated paperwork and/or other data may also be scanned together with the payment product. In another example, the associated paperwork and/or other data may be scanned separately and associated with the payment product.

At step 122, the scanned payment data may be transmitted to an appropriate destination, such as a central processing engine. After the payment data is transmitted, the payment product may be destroyed, at step 124. For example, the payment product may be shredded or otherwise rendered unusable at the system associated with the postal site.

At step 126, the scanned payment data may be received at a remote location, such as the central processing engine. For example, the central processing engine may receive transmitted payment data from a plurality of systems. The central processing engine may be for a specific location, such as a city, district, state, region, or other area. At step 128, a payment type may be identified from the scanned payment data. For example, the payment data may include an actual image of the payment product, as well as a portion of the payment product, such as an identifier, MIRC line or other data. Based on the scanned payment data, a payment product may be categorized or identified as a certain type of product, such as a consumer check, cashier's check, money order, or other type of payment product.

At step 130, an embodiment of the present invention may determine an optimal clearing path based on the payment type and/or other data. For example, if the payment product is a consumer check that meets certain requirements, it may be determined that the consumer check may be converted to an ACH payment. In another example, if the payment product is a money order (or other similar type of instrument), it may be determined that the money order may be cleared as an Image Replacement Document (IRD) where a copy of the money order may be printed at a location and cleared through an appropriate channel. If the payment product is determined to be a corporate check, the corporate check may be printed and cleared as a paper check. In another example, the corporate check may be cleared through an image exchange channel. Other examples may include a debit system, guaranteeing an item and other clearance channels.

At step 132, the payment product may be cleared through the determined clearing path.

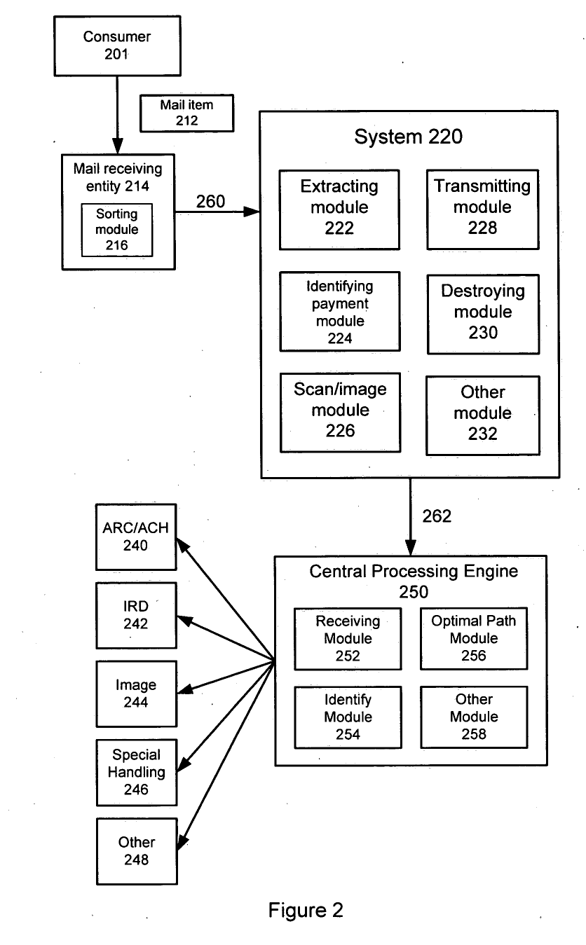

FIG. 2 is a system for electronic check conversion, in accordance with an embodiment of the present invention. According to an exemplary embodiment, consumer 210 represents an individual customer, a small business, corporation or other entity. Consumer 210 may send a mail item 212 to a Mail Receiving entity 214. In addition, the mail item 212 may include a code, which may be a zip code or other identifier. The Mail Receiving Entity 214 may include a United States Post Office branch, a commercial entity associated with the Post Office or other affiliated entity. According to another example, the mail receiving entity 214 may transmit the mail item to an official USPS entity for receiving the mail item. Consumer 210 may physically send the mail item 212 to the Mail Receiving entity 214. In another example, the consumer may transmit the mail item through various other modes of communication, such as fax, electronic transmission, third party intermediary, and/or other modes of communication. For example, consumer 210 may electronically send a payment product to the Mail Receiving entity 214.

At the Mail Receiving entity 214, a sorting module 216 may receive the mail item and route the mail item to a system 220 based on the code via connection 260. System 220 may process the mail item and extract a payment product from the mail item. System 220 may be located at the Mail Receiving entity 214, associated with the Mail Receiving entity 214, or remote from the Mail Receiving entity 214. For example, system 220 may be located within Mail Receiving entity 214. System 220 may occupy an area within Mail Receiving entity 214. In another example, system 220 may be connected or proximal to Mail Receiving Entity 214. Other variations may exist.

As shown in FIG. 2, based on the code, the mail item 212 may be routed via connection 260 to an appropriate system, such as system 220. Further, the mail item 212 is not transmitted through the regular mail channels. The mail item is not routed to the intended recipient's address but processed locally at system 220.

System 220 may include a variety of modules to perform functionality associated with electronic check conversion and other associated functions in accordance with embodiments of the present inventions. System 220 may include extracting module 222, identifying payment module 224, scan/image module 226, transmitting module 228, destroying module 230, and other module 232. These modules may function individually and/or collectively as well as remotely and/or locally.

Extracting module 222 may automatically extract a payment product from the routed mail item containing the payment product. For example, the payment product may include a check (e.g., consumer, corporate, non-profit, other), cashier's check, certified check and/or other type of payment instrument. Once the payment product is extracted, payment data may be identified by Identifying Payment module 224. For example, the payment data may include MICR line, payment amount, routing number, transit number, payee information, payor information, and/or other data associated with the payment product.

Scan/image module 226 may scan the appropriate payment data as well as the actual payment product. The scanned data may be transmitted to an intended recipient, through Transmitting module 230.

After the payment product is scanned and transmitted, the actual physical payment product may be destroyed by destroying module 232. This may involve a shredder or other mechanism for rendering the payment product useless or unusable.

The transmitted payment data may be transmitted to a Central Processing Engine 250 through communication link 262, which may include a network, a private network, Internet, Intranet, and/or other modes of communication, such as wireless, landline, fax, etc. Central Processing Engine 250 may include a variety of modules that perform functionality associated with processing payment data and/or other information in accordance with embodiments of the present invention. Central Processing Engine 250 may include receiving module 252, identify module 254, optimal path module 256 and other module 258. These modules may function individually and/or collectively as well as remotely and/or locally.

Receiving module 252 may receive the transmitted payment data from System 220. The transmitted payment data may include a scanned image of the payment product with any associated paper work, such as remittance advice, coupon, statement, etc. In another example, the transmitted payment data may include a portion of the payment product, which may include MICR line data, an identifier and/or other data.

Identify module 254 may identify a payment type based on the received payment data. Payment type may include consumer check, cashier's check, money order, corporate check, items that may need special handling and/or other categories and payment types.

Optimal path module 256 may determine one or more clearing paths based on the payment type and/or other data. For example, the payment data may be processed by ARC/ACH 240, IRD 242, image replacement 244, special handling 246, and/or other types of processing shown by 248. For example, if the payment product is a consumer check, the payment data may be processed through an ARC process. Other examples may include IRD, image exchange, remote processing and other types of processing.

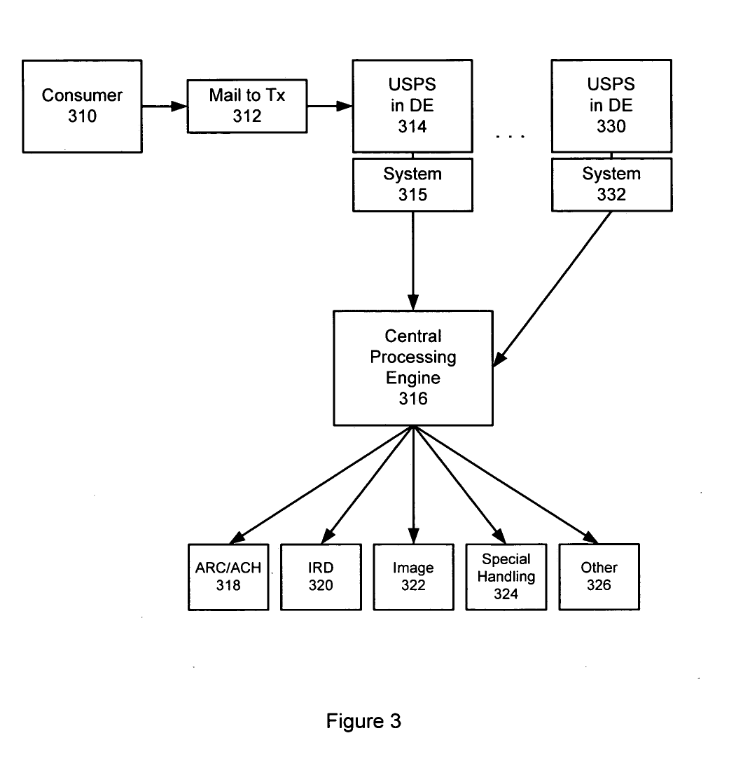

FIG. 3 is an exemplary system for check processing at a distributed postal site, in accordance with an embodiment of the present invention. According to an exemplary embodiment, consumer 310 may be located at a specific state, such as Delaware. Consumer 310 may have a mail item 312 that is addressed to a Texas address having an appropriate code or identifier, which may be the zip code. As far as the consumer 310 is concerned, the mail item 312 is addressed to Texas and will be routed through the appropriate conventional mail channels. The Mail item 312 may be sent to a mail facility located in Delaware. For example, if the mail item 312 is sent from the consumer's home in Delaware, the mail item 312 will be received at a local post office in Delaware, as shown by 314. At the local post office in Delaware 314, the mail item 312 addressed to Texas will be routed to a local processing unit or system 315 in Delaware. For example, a system 315 of an embodiment of the present invention may be integrated with a post office. In this example, the system 315 may be located at the post office 314. In another example, the system may be located at a proximal location (e.g., next building, different floor, etc.).

The system may then electronically transmit scanned payment data to a central processing engine 316. The actual payment product may then be destroyed or otherwise rendered unusable at system 315. The scanned payment data may include a scanned image of the payment product including any associated paper work. In another example, the scanned image may be a portion of the payment product, such as an identifier. Central processing engine 316 may receive scanned payment data from a plurality of systems, as shown by system 332 associated with a postal office 330. Central processing engine 316 may then determine a payment type and determine an optimal clearing path for the payment product. The payment product may then be cleared through an appropriate channel, as shown by ARC/ACH 318, IRD 320, Image Exchange 322, special handling 324 and other channel 326.

An embodiment of the present invention may promote facilities partnership with a mail facility, e.g., USPS. Major USPS processing centers may also serve as lockbox facilities. Floor space in the facilities may be leased for purpose of equipment placement. For example, check processing, such as check truncation, may be performed onsite and non-truncated payments may be converted to IRDs and printed at a remote central location. An embodiment of the present invention may be transparent to customers. More specifically, the consumer making the payment will likely have no idea that a change has occurred in how their payments are processed.

Some of the benefits to the mail facility may include reduced mail volume, increased profit margins from postage paid by consumer even though mail does not move past original city, a new revenue stream, co-location revenue, new use of facilities to decrease downsizing and other advantages.

Some of the benefits to financial institution participants may include reduction of facilities, less need for regional facilities, decreased incoming volume to remaining facilities, increase in lockbox operations margins, decreased operating expenses drive higher margins, unique product with faster availability drives pricing higher or maintains, and other benefits.

Further, other benefits may include an additional 1-2 days of float on payments. Further, processing on location with USPS will save time wasted in transportation of payments, ability to be passed on as value add to drive new sales or held back for additional revenue, smaller equipment sizes (e.g., having ˜50 processing centers instead of 3 will allow for smaller sized equipment to process) and other advantages.

Embodiments of the present inventions may include reduction in “brick & mortar” facilities, conversion to full trip electronic payments, drive National Automated Clearing House Association (NACHA) to expand “truncatable” items leading to added benefit, increased ability to pursue business deemed too small in the current environment, sale of equipment and service to USPS as payments convert to electronic and other benefits.

The present invention is not to be limited in scope by the specific embodiments described herein. Indeed, various modifications of the present invention, in addition to those described herein, will be apparent to those of ordinary skill in the art from the foregoing description and accompanying drawings. Thus, such modifications are intended to fall within the scope of the following appended claims. Further, although the present invention has been described herein in the context of a particular implementation in a particular environment for a particular purpose, those of ordinary skill in the art will recognize that its usefulness is not limited thereto and that the present invention can be beneficially implemented in any number of environments for any number of purposes. Accordingly, the claims set forth below should be construed in view of the full breath and spirit of the present invention as disclosed herein.

1. A method for processing payment products using a computer implemented payment processing system, the method comprising the steps of:
receiving a tangible mail item comprising a payment product and one or more items associated with the payment product, wherein the tangible mail item is addressed to a postal addressed destination in a mail channel;
extracting the payment product and the one or more items associated with the payment product from the tangible mail item;
electronically transmitting, using the computer implemented payment processing system, payment data associated with the payment product to a recipient for processing, wherein processing by the recipient comprises determining, with a computer implemented optimal path module, an optimal clearing path based at least in part on a type of the payment product; and
destroying the payment product at the payment processing system, wherein the tangible mail item is not sent into the mail channel to the postal addressed destination.

2-4. (canceled)

5. The method of claim 1, wherein the computer implemented payment processing system is located at a mail facility.

6. The method of claim 1, wherein the payment data comprises a portion of the payment product that is scanned for electronic transmission.

7. The method of claim 1, wherein the payment data comprises a scanned image of the payment product.

8. The method of claim 1, wherein the one or more items associated with the payment product are electronically transmitted with the payment product.

9. The method of claim 1, wherein the one or more items comprise one or more of remittance advice, a coupon, a statement and accounts receivable data.

10. The method of claim 1, wherein the recipient identifies the type of payment product based on the payment data.

11. (canceled)

12. The method of claim 1, wherein the optimal clearing path comprises one or more of automated clearing house, image replacement document and image exchange channels.

13. (canceled)

14. The method of claim 1, wherein the payment product comprises one or more of a consumer check, corporate check, cashier check, and money order.

15. A computer implemented system for processing payment products, the computer implemented system comprising:
a payment processing system that receives a tangible mail item comprising a payment product and one or more items associated with the payment product; wherein the tangible mail item is addressed to a postal addressed destination in a mail channel, extracts the payment product and the one or more items associated with the payment product from the tangible mail item; electronically transmits payment data associated with the payment product; and destroys the payment product at the payment processing system, wherein the tangible mail item is not sent into the mail channel to the postal addressed destination; and
a computer implemented central processing engine that electronically receives the payment data associated with the payment product and determines an optimal clearing path based at least in part on a type of the payment product.

16-18. (canceled)

19. The system of claim 15, wherein the payment processing system is located at a mail facility.

20. The system of claim 15, wherein the payment data comprises a portion of the payment product that is scanned for electronic transmission.

21. The system of claim 15, wherein the payment data comprises a scanned image of the payment product.

22. The system of claim 15, wherein the one or more items associated with the payment product are electronically transmitted with the payment product.

23. The system of claim 15, wherein the one or more items comprise one or more of remittance advice, a coupon, a statement and accounts receivable data.

24. The system of claim 15, wherein the central processing engine identifies the type of payment product based on the payment data.

25. (canceled)

26. The system of claim 15, wherein the optimal clearing path comprises one or more of automated clearing house, image replacement document and image exchange channels.

27. (canceled)

28. The system of claim 15, wherein the payment product comprises one or more of a consumer check, corporate check, cashier check, and money order.

29. (canceled)

30. (canceled)

31. An article of manufacture for check processing comprising:
at least one processor readable storage medium; and
instructions stored on the at least one processor readable storage medium;
wherein the instructions are configured to be readable from the at least one processor readable storage medium by at least one processor and thereby cause the at least one processor to control a method for processing payment products, the method comprising the steps of:
receive a tangible mail item comprising a payment product, wherein the tangible mail item is addressed to a postal addressed destination in a mail channel;
extract the payment product from the tangible mail item;
electronically transmit payment data associated with the payment product to a recipient for processing, wherein processing by the recipient comprises determining an optimal clearing path based at least in part on a type of the payment product; and
destroy the payment product at the payment processing system, wherein the tangible mail item is not sent into the mail channel to the postal addressed destination.

32. The method of claim 5, wherein the mail facility is a local post office and the computer implemented payment processing system is within or proximate to the local post office.

33. The system of claim 19, wherein the mail facility is a local post office and the payment processing system is within or proximate to the local post office.

34. (canceled)

35. The method of claim 5, wherein the postal addressed destination is beyond the mail facility in the mail channel.

36. The system of claim 19, wherein the postal addressed destination is beyond the mail facility in the mail channel.
